(19) United States
(12) Patent Application Publication
(10) Pub. No.: US 2016/0274652 A1
(43) Pub. Date: Sep. 22, 2016

(54) DETECTING CIRCUIT FOR SIGNAL WIRE OF DISPLAY

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: KAI-LONG HUANG, Wuhan (CN); CHUN-SHENG CHEN, New Taipei (TW)

(21) Appl. No.: 14/721,550

(22) Filed: May 26, 2015

(30) Foreign Application Priority Data
Mar. 20, 2015 (CN) 201510123407.8

(51) Int. Cl. G06F 1/32

(52) U.S. Cl. CPC G06F 1/3296; G06F 1/3218; G06F 1/3265

(57) ABSTRACT

A detecting circuit for detecting a signal wire includes a first port, a second port, a control chipset, a transistor, and a LED. The first port is connected to the second port via the signal wire. The first port includes a first display mark bit pin which is configured to connect to ground when a signal wire connects the first port and the second port well. The control chipset includes a control pin and a detecting pin connected to the first display mark bit pin. The transistor is coupled to the control pin and a power source. The LED is connected to a power source via the transistor. The control pin actives the transistor and thereby active the LED, in event the detecting pin detects that the first display mark bit pin is not connected to ground.

### CROSS-REFERENCE TO RELATED APPLICATION

This application claims priority to Chinese Patent Application No. 201510123407.8 filed on Mar. 20, 2015, the contents of which are incorporated by reference herein.

### FIELD

The subject matter herein generally relates to detecting circuits, and particularly to a detecting circuit for detecting a signal wire of a display.

### BACKGROUND

A desktop computer often includes a host computer and a display connected to the host computer by a signal wire. The host computer sends video signal to the display, and the display shows corresponding information on its screen. Sometime, the screen can not be lighted on because the host computer can not outputs the video signal or the screen breaks down, or some other reason, such as the signal wire being loose with the display or the host computer. It is often difficult for user to clarify that it is what reasons causes the screen can not be lighted on. For example, if the the signal wire is loose to cause the screen to be blank screen and the user does not clarify the reasons, the users may considers the screen being broken down and buys a new display, which causes waste. Thus, there is room for improvement in the art.

### BRIEF DESCRIPTION OF THE DRAWINGS

Implementations of the present technology will now be described, by way of example only, with reference to the attached figures.

FIG. 1 is a block diagram of one embodiment of a detecting circuit for detecting a signal wire of a display.

FIG. 2 is a diagrammatic view of the signal wire connected to the display and a host computer.

FIG. 3 is a circuit diagram of one embodiment of the detecting circuit of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

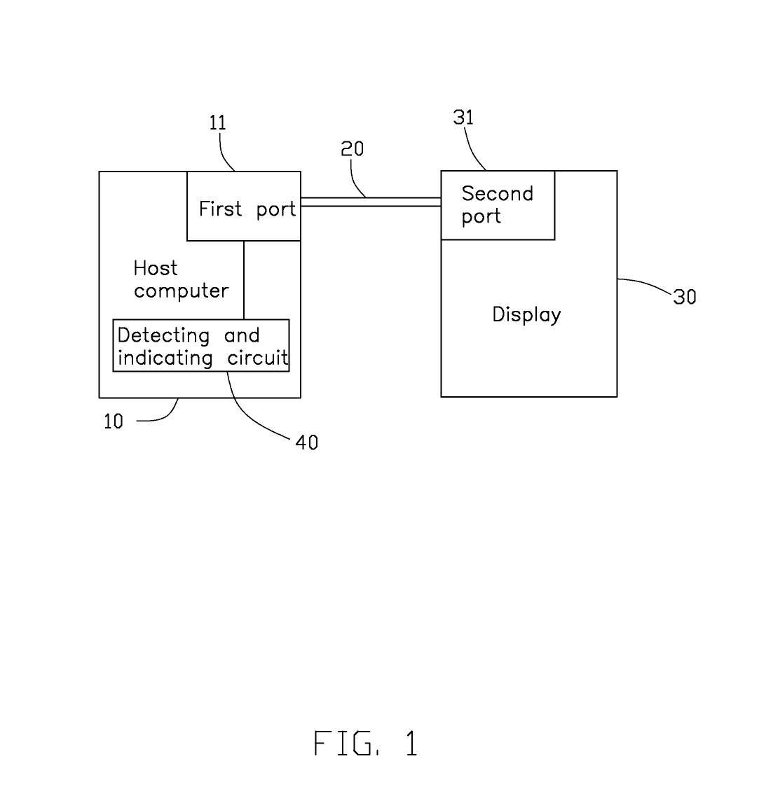

FIG. 1 illustrates one embodiment of a detecting circuit for detecting whether a signal wire 20 is connected well between a host computer 10 and a display 30. The host computer 10 includes a first port 11. The display 30 includes a second port 31. One end of the signal wire 20 can be connected to the first port 11, and the other end of the signal wire 20 can be connected to the second port 11.

A detecting and indicating circuit 40 is set in the host computer 10. The detecting and indicating circuit 40 is connected to the first port 11.

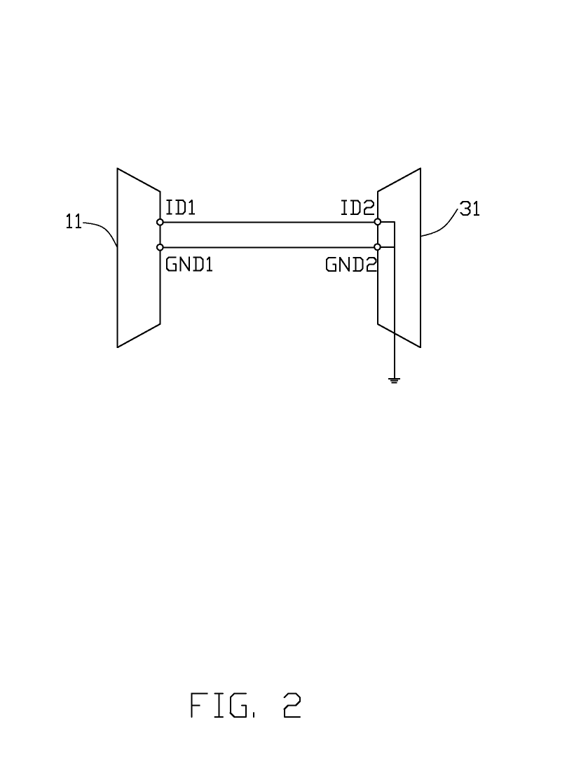

Referring to FIG. 2, the first port 11 includes a first display mark bit pin ID1 and a first ground pin GND1. The second port 31 includes a second display mark bit pin ID2 and a second ground pin GND2. The second display mark bit pin ID2 is connected to the second ground pin GND2 which is connected to ground. When the signal wire 20 connects the host computer 10 and the display 30 well, the first display mark bit pin ID1 is connected to the second display mark bit pin ID2, and the first ground pin GND1 is connected to the second ground pin GND2. Therefore, the first display mark bit pin ID1 is connected to ground via the second display mark bit pin ID2 and the second ground pin GND2. When the signal wire 20 is loose and does not connect the host computer 10 and the display 30 well, the first display mark bit pin ID1 is not connected to ground. In one embodiment, the first port 11 and the second port 31 are video graphics array ports or high definition multimedia interfaces or other video ports.

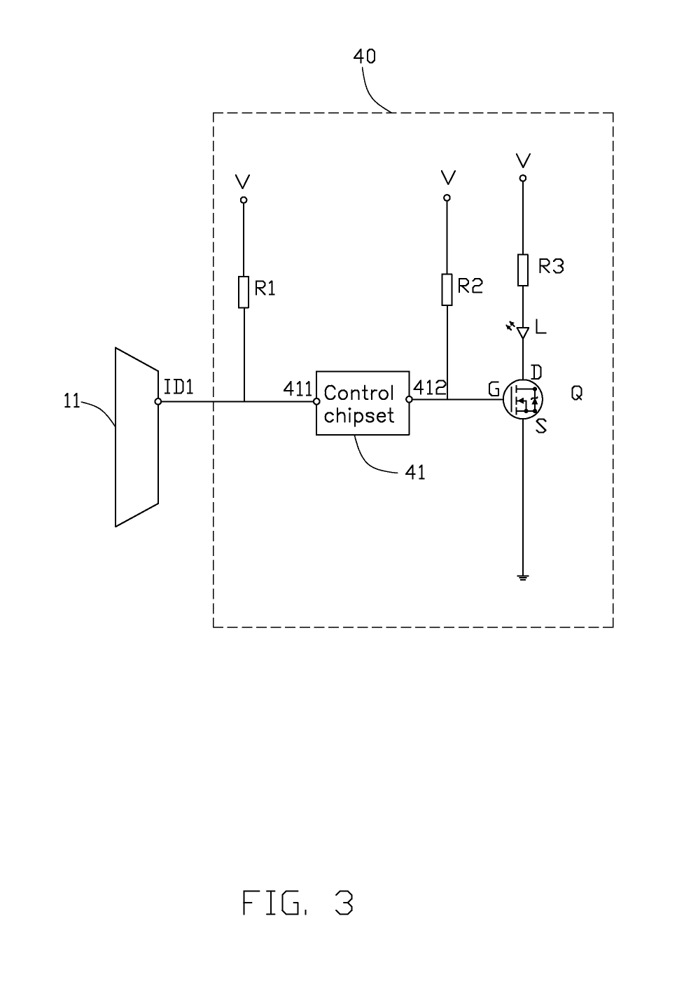

FIG. 3 illustrates a circuit of the detecting and indicating circuit 40 connected to the first port 11. The detecting and indicating circuit 40 includes a power source V, a control chipset 41, a first resistor R1, a second resistor R2, a third resistor R3, a LED L, and a transistor Q. In one embodiment, the transistor Q is a N channel field effect tube. The control chipset 41 includes a pin 411 and a detecting pin 411 and a control pin 412. The control pin 412 is configured to output a high level voltage signal when the detecting pin 411 receives a high level voltage signal, and output a low level voltage signal when the detecting pin 411 receives a low level voltage signal. The detecting pin 411 is connected to the first display mark bit pin ID1. The power source V is connected to the detecting pin 411 via the first resistor R1. The power source V is connected to the control pin 412 via the second resistor R2. The control pin 412 is connected to the gate of the transistor Q. The source of the transistor Q is connected to ground. The power source V is connected to the drain of the transistor Q via the third resistor R3 and the LED L.

To work, when the signal wire 20 connects the first port 11 and the second port 31 well, the first display mark bit pin ID1 is connected to ground and outputs a low level voltage signal to the detecting pin 411. Thus, the control pin 412 outputs a low level voltage signal to the gate of the transistor Q to turn off the transistor Q. The LED L does not lights.

When the signal wire 20 does not connects the first port 11 and the second port 31 well, the first display mark bit pin ID1 is not connected to ground. The power source V provides a high level voltage signal to the detecting pin 411. The control pin 412 outputs a high level voltage signal to the gate of the transistor Q to turn on the transistor Q. The LED L lights to indicates that the signal wire 20 is loose.

The embodiments shown and described above are only examples. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to, and including, the full extent established by the broad general meaning of the terms used in the claims. It will therefore be appreciated that the embodiments described above may be modified within the scope of the claims.

What is claimed is:

1. A detecting circuit for detecting a signal wire, the detecting circuit comprising:
a first port and a second port, the first port configured to connect to the second port via the signal wire, the first port comprising a first display mark bit pin, the first display mark bit pin configured to connect to ground when a signal wire connects the first port and the second port well;
a control chipset comprising a control pin and a detecting pin connected to the first display mark bit pin;
a transistor coupled to the control pin and a power source; and
an LED coupled to the transistor;
wherein the control pin is configured to activate the transistor and thereby activate the LED, in event the detecting pin detects that the first display mark bit pin is not connected to ground.

2. The detecting circuit of claim 1, wherein the control pin is configured to output a high level voltage signal when the detecting pin receives a high level voltage signal, and output a low level voltage signal when the detecting pin receives a low level voltage signal.

3. The detecting circuit of claim 2, wherein the power source is connected to the detecting pin via a first resistor.

4. The detecting circuit of claim 3, wherein the power source is connected to the control pin via a second resistor.

5. The detecting circuit of claim 4, wherein the transistor is a N channel field effect tube, the control pin is connected to a gate of the transistor, a source of the transistor is connected to ground, and a drain of the transistor is connected to the power source via a third resistor and the LED.

6. The detecting circuit of claim 1, wherein the second port comprises a second display mark bit pin which is connected to ground, and the first display mark bit pin is configured to connect to ground when the signal wire connects the first port and the second port well.

7. The detecting circuit of claim 6, wherein the second port comprises a second ground pin connected to ground, and the second display mark bit pin is connected to the second ground pin.

8. A detecting circuit, comprising:
a first port comprising a first display mark bit pin;
a second port comprising a second display mark bit pin which is connected to ground;
a signal wire configured to connect the first display mark bit pin and the second display mark bit pin when the signal wire is connected between the first port and the second port well;
a control chipset comprising a detecting pin connected to the first display mark bit pin;
a transistor coupled to the control chipset and controlled by the control chipset; and
an LED connected to a power source via the transistor;
wherein the control chipset is configured to turn on the transistor to light the LED when the detecting pin detects that the first display mark bit pin does not connect to ground.

9. The detecting circuit of claim 8, wherein the control chipset comprises a control pin connected to the transistor, the control pin is configured to output a high level voltage signal when the detecting pin receives a high level voltage signal, and output a low level voltage signal when the detecting pin receives a low level voltage signal.

10. The detecting circuit of claim 9, wherein the power source is connected to the detecting pin via a first resistor.

11. The detecting circuit of claim 10, wherein the power source is connected to the control pin via a second resistor.

12. The detecting circuit of claim 11, wherein the transistor is a N channel field effect tube, the control pin is connected to a gate of the transistor, a source of the transistor is connected to ground, and a drain of the transistor is connected to the power source via a third resistor and the LED.

13. The detecting circuit of claim 8, wherein the second port comprises a second ground pin connected to ground, and the second display mark bit pin is connected to the second ground pin.
